(19) United States
(12) Patent Application Publication
(10) Pub. No.: US 2011/0187718 A1
(43) Pub. Date: Aug. 4, 2011

(54) METHOD FOR CONVERTING SOUNDS CHARACTERIZED BY FIVE PARAMETERS IN TRIDIMENSIONAL MOVING IMAGES

(76) Inventor: LUCA DIARA, Verciano (IT)

(21) Appl. No.: 13/022,994

(22) Filed: Feb. 8, 2011

(30) Foreign Application Priority Data
Feb. 2, 2010 (IT) PI2010A000013

(51) Int. Cl. G09G 5/22

(52) U.S. Cl. 345/440.1

(57) ABSTRACT

A method for sound analysis, in particular music pieces, and for converting them to images provides the detection of several peculiar parameters of the sounds, such as intensity, main frequency and frequency spectrums, the determination of the sound sources which emitted those sounds, and the representation of the sounds in a three-dimensional reference system in which one axis represents the sound sources and another axis represents the evolution with time of the sounds. The method makes it possible to represent the sounds and their evolution with time because, due to the conversion in images of the harmonic and anharmonic frequencies, it also possible to have a representation of the timbre of the sounds.

### CROSS-REFERENCE TO RELATED APPLICATION

The instant application claims priority to Italian Patent Application Serial No. PI2010A000013, filed Feb. 10, 2010, the entire specification of which is expressly incorporated herein by reference.

### FIELD OF THE INVENTION

The present invention concerns a method for sound analysis, in particular music, and for converting the same in a stream of images.

In particular, the invention concerns a method for analysing musical pieces and for converting the same in a stream of images comprising detecting characteristics of sounds contained in the musical pieces and processing them for producing streams of images which are a visual representation of the musical pieces.

### BACKGROUND OF THE INVENTION

The visual representation of sounds, in particular musical sounds, is used in many fields and for many objects. In display means of instruments for the acoustic characterization of sounds, such as phonometers or harmonic spectrum analyzers, different bidimensional visual representations have been used in which the measured values are represented in a Cartesian reference system, for instance amplitude and frequency, ore one of the above and time.

This kind of representation is the most widely used also for recreational visualizations, when on PC monitors or on other display means are represented the acoustic parameters of sounds processed by specific algorithms. For instance, most software intended to play music files allow many kinds of visualization of the sounds. Anyway, in all the above situations, the parameters of the sound which are represented are the main frequency and the amplitude, which are converted in a stream of geometric images by proper algorithms applying specific mathematical formulas.

The above algorithms are able to represent just few of the parameters which characterize sounds, both they are musical sounds or other kind of sounds, so that it is felt the need of looking for representation methods overcoming the above mentioned limits of the prior art.

### SUMMARY OF THE INVENTION

It is object of the present invention to propose a method for sound analysis by which it is possible to represent the sounds in a simple and effective way, also emphasizing a number of specific parameters of such sounds.

It is further object of the present invention to propose a method for sound analysis through which it is possible to automatically associate the analyzed sounds to specific sound sources.

The above objects are attained by a method for sound analysis, including that of music pieces, wherein the method includes converting the sounds to images, comprising the steps of:

detecting peculiar parameters of sounds emitted by one or more sound sources, in which the peculiar parameters comprise at least intensity and frequency values;

determining the sound sources that emitted the sounds; and

representing the sounds through a reference system in which to each sound source is assigned a specific value of a first datum axis (X axis) and in which each sound is represented, at a certain time, in a plane parallel to an XY datum plane by a plane figure whose center is located at the X value corresponding to the sound source that emitted the sound and the area of the plane figure depends on the intensity of the sound.

Advantageously, the frequency of the sounds is represented on the Y axis of the reference system so that the center of the plane figure is located at a Y value depending on the fundamental frequency of the sound.

Each sound is represented by a plane geometric figure whose position depends on the sound source associated to the sound and on the fundamental frequency of the sound itself.

Advantageously, the step of detecting peculiar parameters of the sounds comprises detecting frequency spectrums of the sound.

Advantageously, after detecting frequency spectrums a step of determining peculiar (harmonic and anharmonic) frequencies in the frequency spectrum is performed.

Advantageously, it also comprises a step of comparing the detected frequency spectrums with stored frequency spectrums, and a step of verifying the matching of detected frequency spectrums with at least one stored frequency spectrum.

Advantageously, after one or more of the steps of match verifying, the detected sound is assigned to a specific sound source.

Advantageously if further detected sounds have peculiar parameters corresponding to the peculiar parameters of the sound assigned to the specific sound source, also the further detected sounds are assigned to the specific sound source.

Thanks to databases where are stored frequency spectrums of specific sounds emitted by specific sound sources it is possible to establish the source of a detected sound if it is stored in the database and then it is possible to correctly represent the sound.

Advantageously, peculiar frequencies detected in the frequency spectrums of the sound are represented through plane figure having same center position and same shape of the plane figure representing the main frequency of the sound.

### BRIEF DESCRIPTION OF THE DRAWINGS

The above and more features of the present invention will be better understood by way of an embodiment, given as a not limiting example, that will be described in the followings with reference to the accompanying drawings, in which:

FIG. 1 shows a schematic top view of a layout of musical instruments in an orchestra which shows a step of a method according to the present invention;

FIG. 2 shows a visual representation of music sounds made through a method of the invention;

FIG. 3 shows a further visual representation of sounds made through a method of the invention;

FIG. 4 shows a chart of the harmonic spectrum of a sound; and

FIG. 5 shows a further possible visual representation of sounds which can be made with a method of the invention.

### DETAILED DESCRIPTION OF THE INVENTION

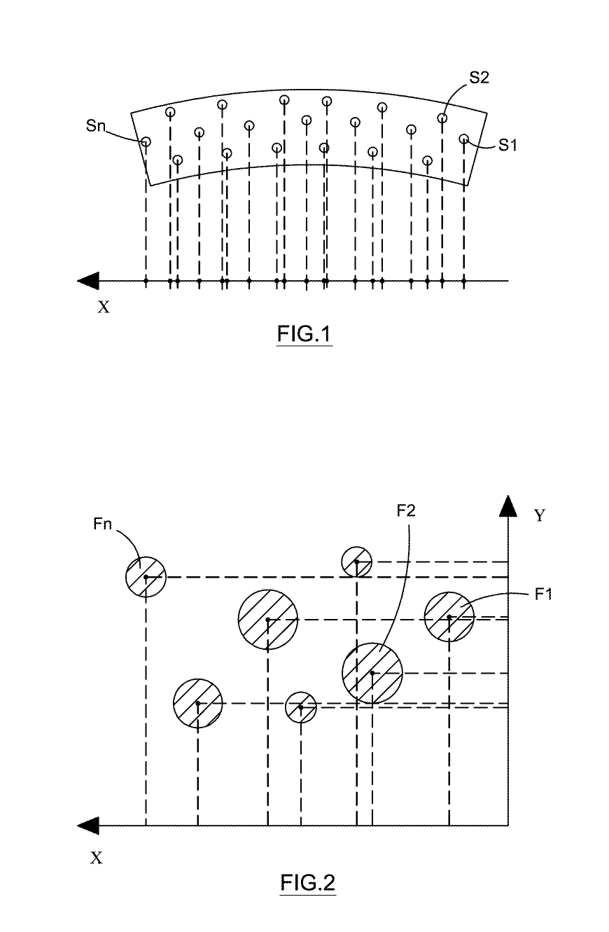

In FIG. 1 it is shown the layout of musical instruments S (S1, S2, . . . , Sn), corresponding to single sound sources, in a generic orchestra. To each instrument is assigned a value on the X axis of the reference system. In the present embodiment it is taken into account the physical position of the instruments and the X value of each instrument is determined as the projection of the instrument, in a top view, on a straight line extending in front of the orchestra. In this way it is taken into account the sum of the visual and acoustic perception of a listener seating in the stalls of a theatre in front of the orchestra. Obviously the X values can be assigned to the sound sources in many different ways and it depends on the kind of sounds to be converted in images. When converting in images the music played by an orchestra the physical layout of the instruments can be still taken into account but they could be evenly spaced on the X axis, or another different representation could be adopted. If the sounds are recorded in analogue or digital storing means, it is possible to identify, through proper ways and algorithms, the sound sources that emitted them, both when they are classic musical instruments and when they are other kinds of sound sources, and to the sound sources can be arbitrarily assigned an X value. As it is possible to see in FIG. 2 upon contemporaneous emission of a set of sounds, in the XY plane they are represented by circles whose position depends on the sound source that emitted the sound and the frequency of the sound, while the dimension of the circle depends on the intensity of the sound.

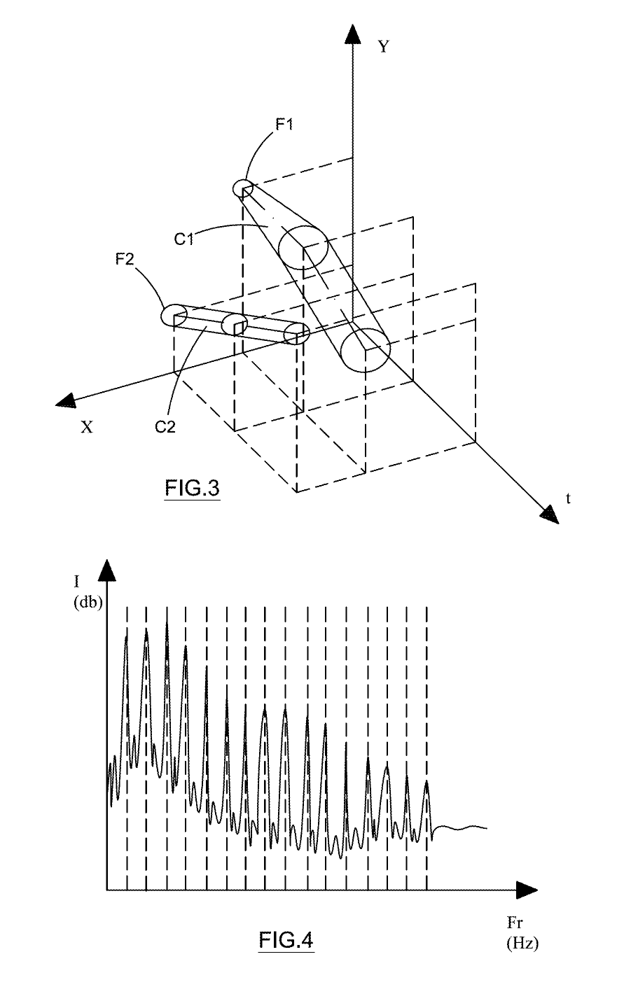

In FIG. 3 it is shown a three-dimensional reference system in which on the third axis there is time. As it can be seen, by using a sufficiently high sound sample rate and a simple linear interpolation the time progress of the sounds is represented by solid figures, C1, C2, such as, for instance, cylinders or cones. In particular, in FIG. 3 are represented a cylinder with inclined axis, C2, which is obtained when the frequency of the sound increase and its intensity remains constant, and a further solid, C1, which is composed of a con with straight axis and a cylinder with inclined axis, which is obtained when we have at the beginning an increase of intensity at a constant frequency and then a change in frequency at a constant intensity. Obviously, when a sound of a certain frequency emitted by a certain sound source stops, or has a pause, the solid breaks and it can be considered completed.

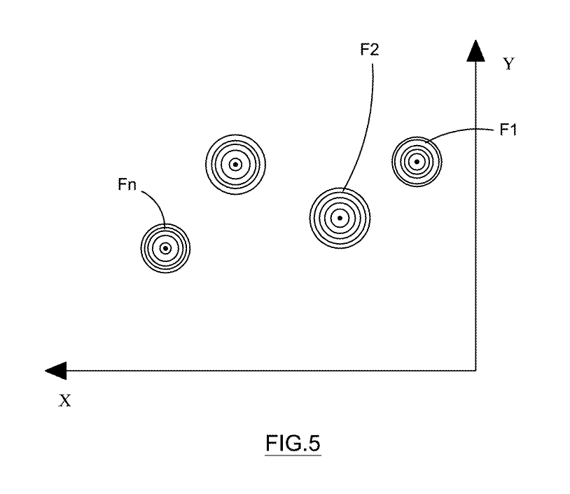

A very detailed representation, mainly in case of musical sounds, is obtained by using a harmonic spectrum detector for detecting the evolution of the frequency spectrum of the sounds and by using this last for identifying the sound source and also for visually characterising in a very specific way the analyzed sounds. An example of a frequency spectrum of a certain sound at a certain time is shown in FIG. 4. The frequency spectrums of the analyzed sound are processed and compared with existing databases where are stored, properly processed and characterized, peculiar frequency spectrums of musical instruments and other sound sources. By comparing, through specific algorithms, the frequency spectrums of the analyzed sound with the frequency spectrums stored in the above databases, it is checked if the detected frequency spectrums match the stored frequency spectrums and in this way the sound source is identified and assigned. In most cases when a single frequency spectrum or a single note (frequency) matches it could be not sufficient for determining without doubts the sound source. More correctly, a specific sound source could be identified if, in a certain amount of time, several detected frequency spectrums match stored frequency spectrums which are peculiar of a certain sound source and, in case, if the way of evolving of the frequency spectrums of a certain analyzed sound matches with the stored way of evolving of frequency spectrums of a certain sound source. For instance, if the frequency spectrums of 10 different notes emitted by a trumpet and their way of evolving are available in the database, and during the analysis of a music piece some of them are identified and their way of evolving, then all the sounds having specific characteristics of the frequency spectrum can be assigned to the sound source “trumpet” and they are consequently represented.

Once the sound source is identified it could be assigned with a specific value on the X axis and specific representation features, for instance as regards the color or the pattern assigned to the geometric figure.

From the frequency spectrums we can have a further important information useful for visually characterizing a sound. In fact, instead of representing only the main frequency, also a certain number of the subsequent harmonics could be represented. The subsequent harmonics have a frequency which is a multiple of the frequency of the main harmonic and their intensity is usually lower and, according to the above proposed scheme, they would be represented in a position having the same value on the X axis but a greater value on the Y axis. This kind of representation could be deceptive since even if a single note is played, composed of its main harmonics and a number of subsequent harmonics, it would be represented by several figures just like a number of different notes would be contemporaneously played. As shown in FIG. 5, to avoid this deceptive effect, the subsequent harmonics can be represented concentric to the main harmonic, for instance of chromatic tonality lighter than the color of the main harmonics of a proper percentage which depends on the difference in frequency.

So, a certain sound will be represented so that it is characterized not only by its intensity and its main frequency, but more correctly its representation will depend on its frequency spectrum which contributes to make the timbre of the sound.

Many types of sounds are also characterized, further than by harmonic frequencies, also by a certain number of anharmonic frequencies, that is frequencies which are not multiples of the main frequency. For some types of sounds, irrespective that they are produced by classic music instruments or not, some anharmonic frequencies are very important for characterizing the sound and then the analysis of the frequency spectrums must also consider these anharmonic frequencies. Once the sound source has been identified by comparing the sound with the database of frequency spectrums, it is possible to represent the sound also with the anharmonic frequencies which characterize it.

A representation as above described, in which different frequencies are represented concentric to the main frequency, can be adopted also for representing musical chords. In music chords are a set of sounds having a specific tone ratio among them which are played contemporaneously to create a particular sound effect. For instance a chord could be represented as a figure having the Y value (frequency) of the lower note among the note which form the chord.

As an example in the following it is described a preferred representation mode which can be used mainly in case of sounds emitted by classic musical instruments.

According to a specific theory, within a musical octave it is possible to recognize a circle of twelve notes placed in series according to a specific scheme in which beginning from a note it is followed by its fifth, and proceeding this way, the so called circle of fifths in which two sounds that are diametrally opposite are considered complementary sounds. In a similar way, in painting, it is possible to make a circle composed of twelve base colors, arranged so that mixing two diametrally opposite colors it is obtained the color grey. The diametrally opposite colors are complementary colors and the circle obtained in this way is called color spectrum. By making a correspondence between the circle of the fifths and the color spectrum it is possible to associate to each note of an octave a different color of the color spectrum. So to each note of an octave corresponds a different specific base color. The other musical octaves, lower or higher, may be represented by making the corresponding color darker or lighter of a certain percentage. In addiction, each note, characterized by its color, could be further characterized as a function of the instruments that emitted it. In fact, the analysis of the frequency spectrum will allow the identification of a sound source allowing not only to define its value on the X axis but it the note could also be further characterized with specific representation features. For instance, if the sound source has been identified as a percussion instrument, the color which is typical of that note could be mixed with one or more colors which are assigned to percussion instruments, which, in this way, contribute to represent the timbre of the instrument which is affected also by the resonant sounds emitted by resonator means of the instrument, for instance a resonance chamber. For instance, a percussion instrument could be characterized by dark colors and a pattern giving a look of roughness. In case the sound source is a harp light colors could be used together with a much more smooth pattern. Finally, in the same note, will be visible, concentric to the main frequency, some of the subsequent harmonic frequencies.

As it could be easily comprehended, thanks to the method of the invention it is possible to obtain to visual representation of sounds which allows appreciating in simple easy and fast way features of the sounds which are even of an advanced and complex type, by converting acoustic details in visual details and, in particular chromatic details.

The method of the invention is based on a punctual and detailed characterization of the sounds but, anyway, the representation modes could be also much different from what above disclosed and they could also be completed with further visual effects without losing the advantages deriving from the invention.

A preferred representation mode uses a white background, but the background color and the lightness could be automatically adapted both to the colors and the shapes of the figures representing the sounds and to the display means.

The acoustic effects that can be obtained by changing the volume of a sound source or by equalizing it in order to enhance or soften specific frequencies can also be reproduced in the visual representation. For instance, a general increase of the volume can be represented with a zooming of the whole image, in which the proportions between the shapes and their distances remains unchanged. Differently, an equalization, in which is increased only the volume of specific frequencies can be represented by zooming only the figures whose canter is comprised in the specific range of the Y axis (axis of the frequencies).

In addiction, it is possible to uniformly and proportionally increase the size of the figures whose center is contained in a specific range of the X axis (axis of the sound sources). This last kind of equalization is not normally possible with the usual sound reproducing means and it corresponds to amplifying only specific sound sources. A further type of equalization consists of uniformly and proportionally increase the size of the figures whose center is comprised in a rectangular area of the XY plane, and it is just like making at the same time an equalization based on specific frequencies and an equalization based on specific sound sources.

The way the “timbre”, of specific sound sources is represented, that is their peculiar frequency spectrums, can be chosen in order to soften or to enhance specific features. For instance, the color, the transparency and the pattern of a certain figure, which represent a sound, could depend on the presence of specific harmonic or anharmonic frequencies.

A partial representation of the sounds could also be given by using only some of the information that we have about the sounds. In particular, projection views on any plane of the reference system could be used, or one or more of the parameters of the sound could be suppressed. For instance, the frequency of the sound could be not represented on the Y axis and every sound would be given the value Y=0.

Finally, once defined and assigned all the possible variables of the representation (position, size, color, transparency, pattern) it is obvious that the reverse process can be performed of converting the images in the corresponding sounds.

The above and other changes could be carried out to the method of the invention, still remaining within the ambit of protection defined by the following claims.

What is claimed is:

1. A method for sound analysis, including that of music pieces, wherein the method includes converting the sounds to images, comprising the steps of:
detecting peculiar parameters of sounds emitted by one or more sound sources, in which said peculiar parameters comprise at least intensity and frequency values;
determining the sound source that emitted said sound; and
representing said sounds through a reference system in which to each sound is assigned a specific value of a first datum axis (X axis) and in which each sound is represented, at a certain time, in a plane parallel to an XY datum plane by a plane figure whose center is located at the X value corresponding to the sound source that emitted said sound and the area of said plane figure depends on the intensity of said sound, and in which the frequency of said sound is represented on the Y axis of said reference system so that the center of said plane figure is located at a Y value depending on the frequency of said sound.

2. The method according to claim 1, wherein said step of detecting peculiar parameters of said sounds further comprises detecting frequency spectrums of said sounds.

3. The method according to claim 2, wherein after detecting said frequency spectrums, a step of determining peculiar frequencies in said frequency spectrums is performed.

4. The method according to claim 2, further comprising the step of comparing said detected frequency spectrums with stored frequency spectrums, and the step of verifying the matching of said detected frequency spectrums with at least one stored frequency spectrum.

5. The method according to claim 4, wherein after one or more of said steps of match verifying has been performed, the detected sound is assigned to a specific sound source.

6. The method according to claim 5, wherein further detected sounds, having peculiar parameters corresponding to the peculiar parameters of said sound assigned to said specific sound source, are assigned to said specific sound source.

7. The method according to claim 3, wherein said peculiar frequencies detected in said frequency spectrums of said sound are represented through plane figures having the same center position and same shape of the plane figure representing the main frequency of said sound.

8. The method according to claim 3, wherein a plurality of sounds composing a musical chord is represented by figures which are concentric to the figure which represents one of said sounds.
